(19) United States
(12) Patent Application Publication
(10) Pub. No.: US 2012/0096209 A1
(43) Pub. Date: Apr. 19, 2012

(54) Multi peripheral accelerating apparatus

(76) Inventor: Yu Shin Wang, Hsinchu Hsien (TW)

(21) Appl. No.: 12/925,175

(22) Filed: Oct. 15, 2010

(51) Int. Cl. G06F 13/14; G06F 12/06

(52) U.S. Cl. 710/305; 711/104; 711/E12.078

(57) ABSTRACT

A multi peripheral accelerating apparatus includes a processor device disposed on a main board, a primary memory and a controller disposed on the main board and electrically connected to the processor device for exchanging information with the processor device, a secondary memory disposed on the main board and electrically connected to the controller, and one or more peripherals disposed on the main board and electrically connected to the controller for allowing the information to be transmitted or exchanged from the peripherals to the secondary memory when the processor device is transmitting or exchanging information with the primary memory.

### BACKGROUND OF THE INVENTION

1. Field of the Invention

The present invention relates to a multi peripheral accelerating apparatus, and more particularly to a multi peripheral accelerating apparatus including an accelerating structure or arrangement for allowing a processor device and a peripheral to access or fetch different memories and to decrease the waiting time for the processing of the processor device and to increase the system processing or operating effect.

2. Description of the Prior Art

Typical multi peripheral apparatuses, as shown in FIGS. 1 and 2, comprise a primary or main circuit board 10, a micro processor or processor device 11 disposed or attached or mounted on the main board 10, a random access memory (RAM) 12 also disposed or attached or mounted on the main board 10 and electrically connected or coupled to the processor device 11 for exchanging information with the processor device 11, one or more slots or sockets 13 further disposed or attached or mounted on the main board 10 and electrically connected or coupled to the RAM 12, and a peripheral 14 attached or mounted or plugged or coupled to the socket 13 and electrically connected or coupled to the socket 13 for exchanging information with the RAM 12 and the processor device 11, and for allowing the information in the peripherals 14 to be treated or processed by or with the processor device 11.

However, as shown in FIG. 2, the information in the peripherals 14 should first be sent or transmitted to the RAM 12 before the processor device 11 may treat or process the information in the peripherals 14, in addition, the processor device 11 and the peripherals 14 use the same RAM 12 and may not access or fetch the information from the RAM 12 simultaneously, i.e., the peripherals 14 may not access or fetch or exchange or process the information to and from the RAM 12 when the processor device 11 is transmitting or exchanging information with the RAM 12, similarly, the processor device 11 also may not access or fetch or exchange or process the information to and from the RAM 12 when the peripherals 14 are transmitting or exchanging information with the RAM 12 such that the processing or operating effect of the system is greatly decreased.

The present invention has arisen to mitigate and/or obviate the afore-described disadvantages of the conventional multi peripheral apparatuses.

### SUMMARY OF THE INVENTION

The primary objective of the present invention is to provide a multi peripheral accelerating apparatus including an accelerating structure or arrangement for allowing a processor device and a peripheral to access or fetch different memories and to decrease the waiting time for the processing of the processor device and to increase the system processing or operating effect.

In accordance with one aspect of the invention, there is provided a multi peripheral accelerating apparatus comprising a main board, a processor device disposed on the main board, a first memory disposed on the main board and electrically connected to the processor device for exchanging information with the processor device, a controller disposed on the main board and electrically connected to the processor device for exchanging information with the processor device, a second memory disposed on the main board and electrically connected to the controller, and at least one peripheral disposed on the main board and electrically connected to the controller.

The peripheral is selected from an internet card, a peripheral component interconnect (PCI), or a universal serial bus (USB).

The first memory is selected from a random access memory (RAM), and the second memory is also selected from a random access memory (RAM).

The main board includes at least one socket electrically connected to the controller for engaging with the peripheral.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating a typical multi peripheral apparatus;

FIG. 2 is a block diagram of the typical multi peripheral apparatus;

FIG. 3 is another perspective view illustrating a multi peripheral accelerating apparatus in accordance with the present invention;

FIG. 4 is a further perspective view similar to FIG. 3, illustrating the other arrangement of the multi peripheral accelerating apparatus;

FIG. 5 is a block diagram of the multi peripheral accelerating apparatus; and

FIGS. 6, 7, 8 are block diagrams similar to FIG. 5, illustrating the operation of the multi peripheral accelerating apparatus.

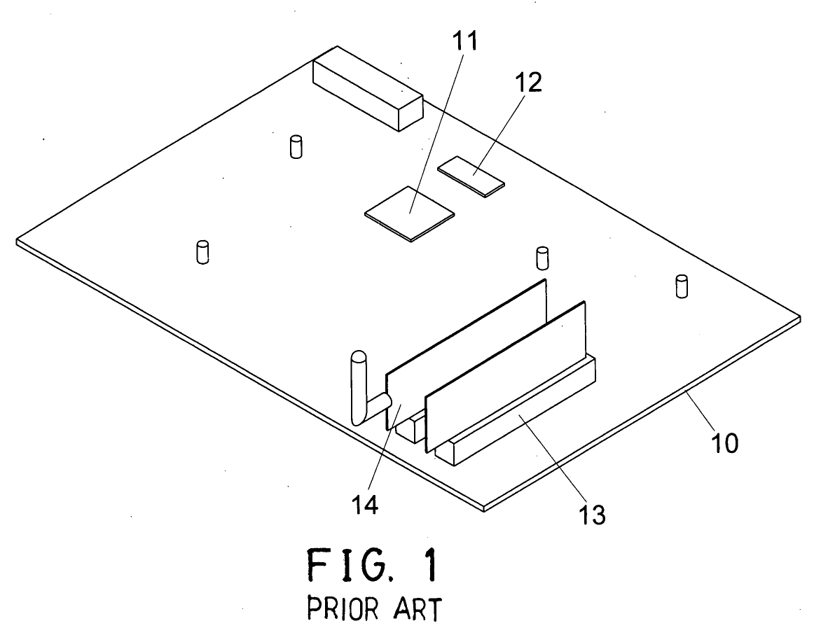

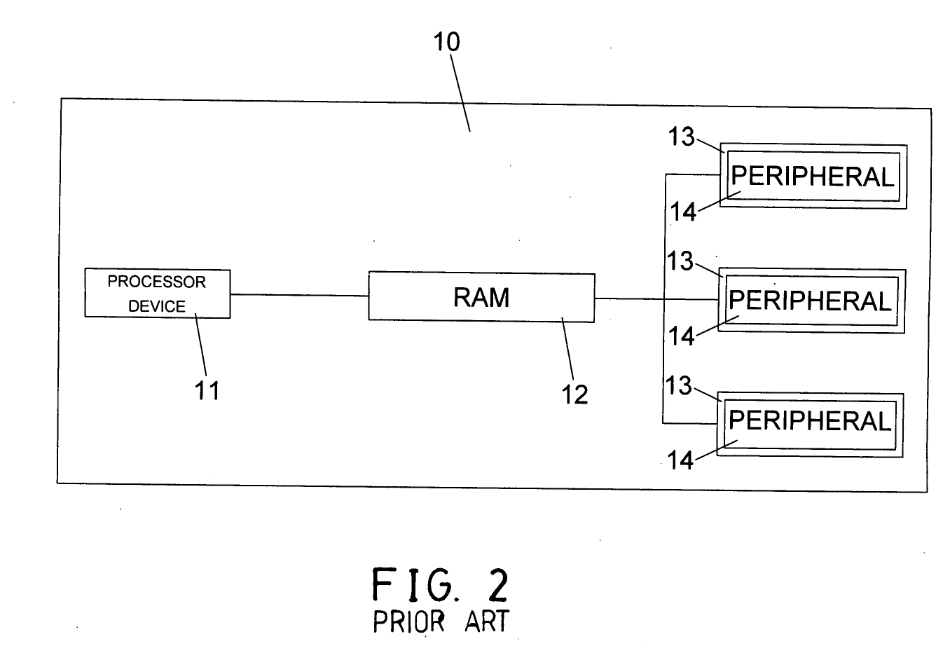

### DETAILED DESCRIPTION OF THE PREFERRED EMBODIMENT

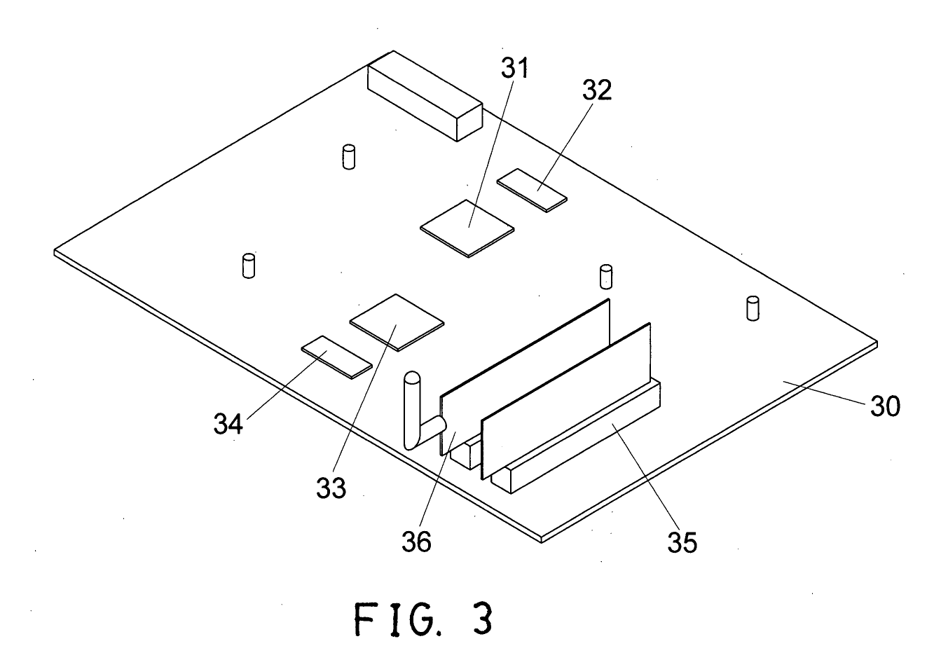

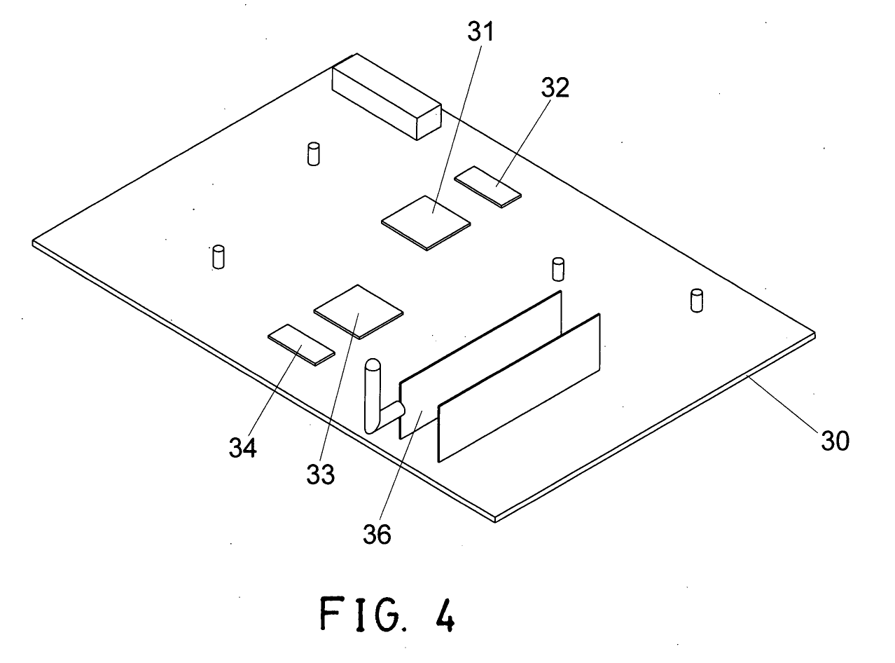

Referring to the drawings, and initially to FIGS. 3 and 4, a multi peripheral accelerating apparatus in accordance with the present invention comprises a primary or main circuit board 30, a micro processor or processor device 31 disposed or attached or mounted on the main board 30, a first memory 32 also disposed or attached or mounted on the main board 30 and electrically connected or coupled to the processor device 31 for exchanging information with the processor device 31, in which the first memory 32 may be selected from a random access memory (RAM) or the like.

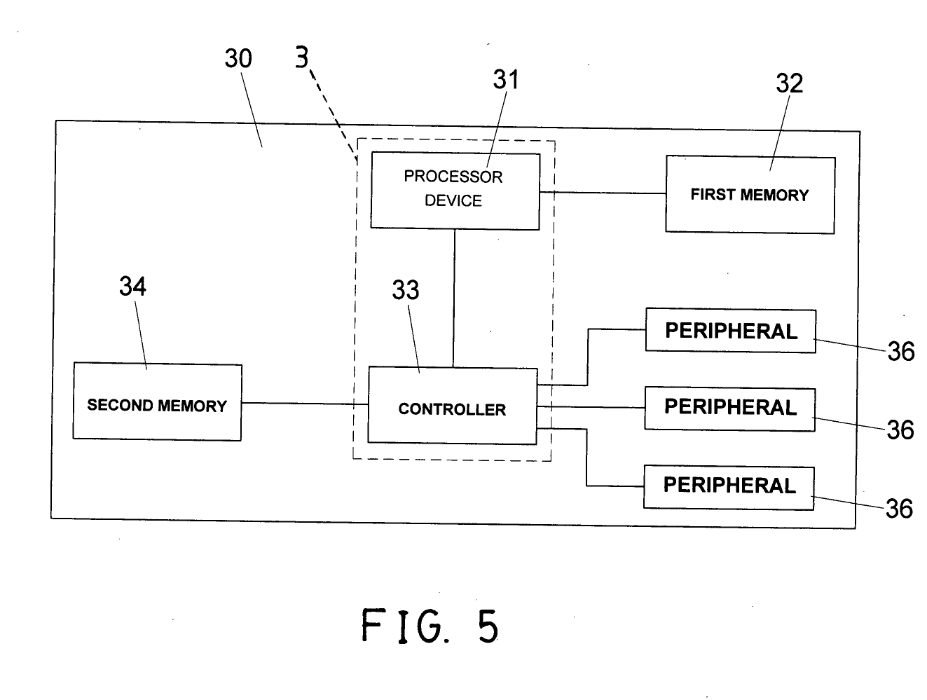

The main board 30 further includes a controlling device or controller 33 also disposed or attached or mounted on the main board 30 and electrically connected or coupled to the processor device 31 for exchanging information with the processor device 31, in which the controller 33 and the processor device 31 may be disposed or attached or mounted or arranged in an integrated circuit 3 (FIG. 5). A second memory 34 is further provided and disposed or attached or mounted on the main board 30 and electrically connected or coupled to the controller 33 for exchanging information with the controller 33, in which the second memory 34 may be selected from a random access memory (RAM) or the like.

One or more peripherals 36 are further provided and disposed or attached or mounted on the main board 30 and electrically connected or coupled to the controller 33 for exchanging information with the controller 33, in which the peripherals 36 may be selected from the internet card, the peripheral component interconnect (PCI), the universal serial bus (USB) or the like. As shown in FIG. 3, the main board 30 may further include one or more slots or sockets 35 disposed or attached or mounted on the main board 30 and electrically connected or coupled to the controller 33 for attaching or mounting or plugging or coupling to or engaging with the peripherals 36, and the slots or sockets 35 may also be selected from the peripheral component interconnect (PCI), the universal serial bus (USB) or the like.

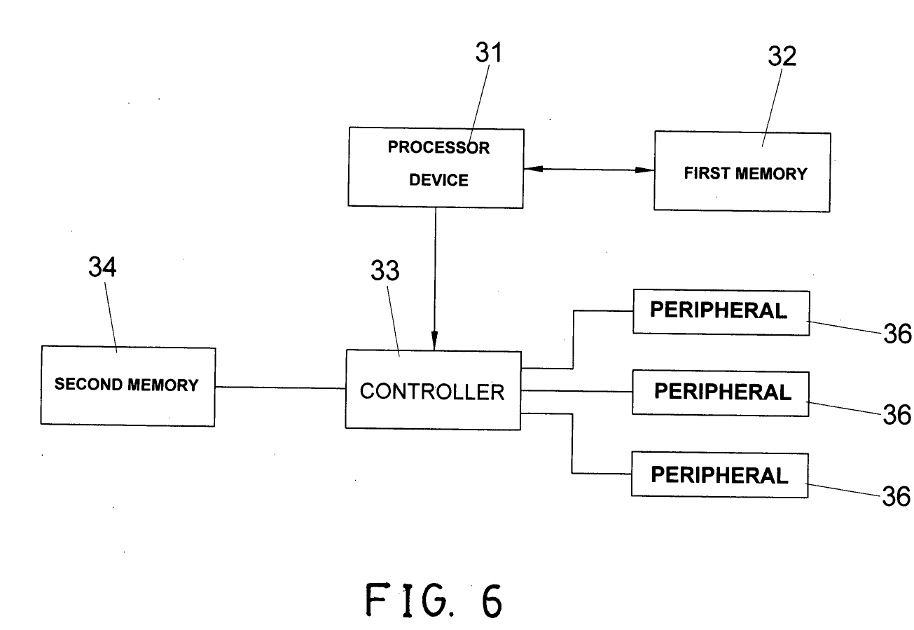

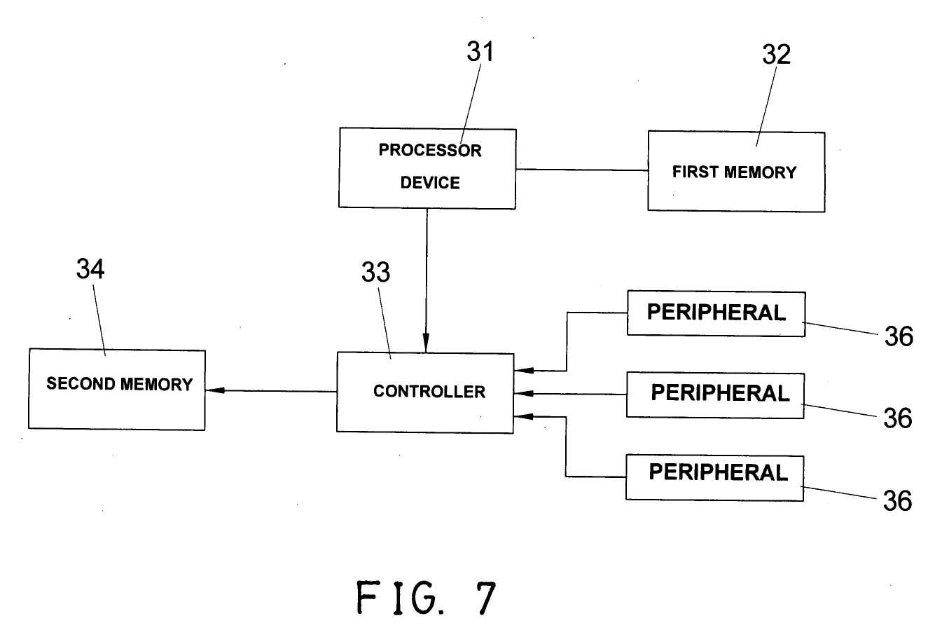

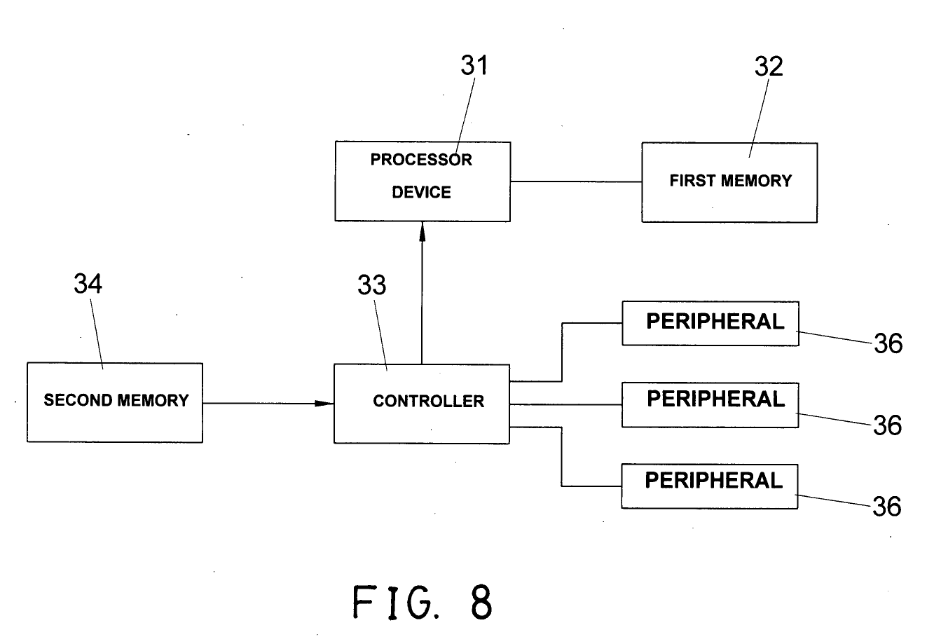

In operation, as shown in FIG. 6, when the processor device 31 is transmitting or exchanging information with the first memory 32, the processor device 31 may actuate or operate the controller 33 to move or transmit the information from the peripherals 36 to the second memory 34 (FIG. 7), and when the processor device 31 is required to transmit or exchange information with the peripherals 36, as shown in FIG. 8, the controller 33 may directly transmit or exchange the information of the peripherals 36 that have been stored in the second memory 34 to the processor device 31, such that the processor device 31 is not required to wait for the transmitting or exchanging of the information from the peripherals 36 to the second memory 34, and such that the processor device 31 may readily and quickly and easily treat or process the information of the peripherals 36 and the first memory 32, and such that the processing or operating effect of the system may be greatly decreased.

Accordingly, the multi peripheral accelerating apparatus in accordance with the present invention includes an accelerating structure or arrangement for allowing a processor device and a peripheral to access or fetch different memories and to decrease the waiting time for the processing of the processor device and to increase the system processing or operating effect.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A multi peripheral accelerating apparatus comprising:
a main board,
a processor device disposed on said main board,
a first memory disposed on said main board and electrically connected to said processor device for exchanging information with said processor device,
a controller disposed on said main board and electrically connected to said processor device for exchanging information with said processor device,
a second memory disposed on said main board and electrically connected to said controller, and
at least one peripheral disposed on said main board and electrically connected to said controller.

2. The multi peripheral accelerating apparatus as claimed in claim 1, wherein said at least one peripheral is selected from an internet card, a peripheral component interconnect (PCI), or a universal serial bus (USB).

3. The multi peripheral accelerating apparatus as claimed in claim 1, wherein said first memory is selected from a random access memory (RAM).

4. The multi peripheral accelerating apparatus as claimed in claim 1, wherein said second memory is selected from a random access memory (RAM).

5. The multi peripheral accelerating apparatus as claimed in claim 1, wherein said main board includes at least one socket electrically connected to the controller for engaging with the at least one peripheral.
